(19) United States
(12) Patent Application Publication
(10) Pub. No.: US 2008/0035067 A1
(43) Pub. Date: Feb. 14, 2008

(54) PET FEEDING SYSTEM AND APPARATUS

(76) Inventor: PAT OGDEN, Scarsdale, NY (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/530,687

(22) Filed: Sep. 11, 2006

(30) Foreign Application Priority Data
Aug. 8, 2006 (US) PCT/US06/30998

(51) Int. Cl. A01K 5/01

(52) U.S. Cl. 119/61.5

(57) ABSTRACT

The present invention provides a pet bowl that is releasably securable to a stabilizing base that also stores a lid during use. Optional bowl liners are replaceable and disposable, allowing the use of the pet bowl system during travel with or without the liners. A lid-lip sealing construction allow users to seal a lid over a partially used liner in the bowl for temporary storage or transport. An opening in the stabilizing base provides an optional storage region. Bowl liners may be individually sealed, include multiple sections, and may be sold separately for the travel convenience of pet owners. The bowl liners may also include a liner-lip sealing or other construction that removably secures the liner in the bowl during use while providing a rim-tab to enable easy removal.

### CROSS REFERENCE TO RELATED APPLICATIONS

This application claims priority to U.S. Provisional App. No. 60/706,241 filed Aug. 8, 2005, and International Application No. PCT/US2006/030998 filed Aug. 8, 2006 the entire contents each of which are herein incorporated by reference.

### IMAGE SELECTED FOR PUBLICATION

FIG. 2

### BACKGROUND OF THE INVENTION

1. Field of the Invention

The present invention relates to a pet feeding system and apparatus to enable the same. More specifically, the present invention relates to an assembly of pet-feeding elements providing a stabilized bowl for feeding use allowing the use of a sealing lid and removable liners for ready clean-up, storage, and transport.

2. Description of the Related Art

The related art involves the use of pet feeding bowls and liners therefore. The related art includes liners that snap in with complicated profiles, liners that lock in with a physical lock, and liners that are held by adhesive members, as well as those liners that just fit in with wrap-around structures.

U.S. Pat. No. 4,428,325 (Koch) and U.S. Pat. No. 4,800,845 (Budd), and published patent applications US 2005/0045113 (Wetterer et al) and US 2006/0027176 (McQuade et al) provide a sampling of possible designs involving pet bowls having some form of liner. For example, in Koch a single bowl having a bounded bowl form is presented and includes a liner formed to extend over a bowl rim and substantially downwardly along an outer side wall of the bowl to engage a plurality of inward-facing regions for an elastic a “snap-engagement” thereof driven by a corresponding protuberance on the liner. As a consequence of this design, the Koch liner is retained at a rim portion without close fitting the entire bowl shape. Unfortunately, the Koch liner also requires expensive and difficult to use thermo-forming plastic molds and strict attention to manufacturing detail to ensure a tight fit, as well as the use of high-molecular weight plastics effective to form a rigid self-supporting lining.

Reference is also made to other US references providing a liner and some form of settling support bowl; these include U.S. Pat. No. 6,089,187 (Gaspary) and U.S. Pat. No. 6,644,241 and US 2003/00339896 (both by Brown), as well as US 2005/0039689 and World patent WO 03/065797 (both by Mossmer) and British patent GB 2,304,273 (Stungo et al).

Finally, it is also noted that a limited number of physical means of joining a liner to a bowl are known in the art, and include spring clips and holding rings. These related references include U.S. Pat. No. 3,698,594 (Boehlert), U.S. Pat. No. 3,991,719 (Bruce), and U.S. Pat. No. 5,709,168 and U.S. Pat. No. 5,782,374 (Both by Walker).

In considering the above liner conceptions it is noted that each attempt fails to adequately address the need for an inexpensive liner and flexible liner that may be co-secured with a lid to a bowl to allow temporary storage and secure transport at need. What is also not appreciated by the related references is the use of a liner system that is pre-filled and sealed with food available for individual purchase and alternative storage within a bowl during travel.

As is to be expected from the above reference review, it is also known in the art to provide a permanent storage container for traveling with pet food as well as a combined food storage and pet bowl assembly.

As will be appreciated from U.S. Pat. No. 5,823,136 (Zarski) the use of two semi-cylindrical bowls hinged side-by-side are known and include internally storeable permanent containers, so that when folded the entire kit forms a cylinder, each portion containing a single container for storing food or water for a pet.

Also known in the art are U.S. Pat. No. 5,752,464 (King) and U.S. Pat. No. 6,443,096 (Prydie) both of which are for travel food kits for pets, each including two lidded bowls hinged side-by-side which when folded form a spheroid with snap fit handles forming a closing latch mechanism. In the King reference the securing lids are threaded and screw-on whereas with the Prydie reference has two separate lids that snap fit into recesses.

Finally it is also known in the art to provide two separate pet dishes that may be mounted relative to each other. In U.S. Pat. No. 5,125,363 (McGaha), shown are two pet food dishes, separable, which are mounted one above the other and locked into place, to place for food and water in a convenient pet-consumption position. In U.S. Pat. No. 5,884,580 (Faircloth, Jr.), a single transportable container includes a handle for transport and is divided into two separate but joined compartments for food and water.

The contents of each of the above-noted related art references in incorporated herein by reference in their entirety to aid the public understanding of the present invention.

What is not appreciated by the prior art (and what therefore is proposed as needed) is a travel bowl and liner system that enables a user to secure a lid over the liner for temporary storage, that provides for a secure bowl-base interconnection for improved stability, and allows for a system providing optional pre-filled liners for travel purposes and optional storage within a bowl, as well as an convent lid storage system to avoid unintended separation.

Accordingly, there is a need for an improved pet bowl system for travel and home use that responds to at least one of the needs noted above.

### OBJECTS AND SUMMARY OF THE INVENTION

One aspect of the present invention is to provide a pet feeding system and apparatus to enable the same. More specifically, the present invention relates to an assembly of pet-feeding elements providing a stabilized bowl for feeding use, a sealing lid, a liner, and a construction enabling ready clean-up, storage, and transport.

Another aspect of the present invention is to provide a pet feeding system that allows a lid to be secured over a liner for temporary storage and later re-use.

Another aspect of the present invention is to provide a bowl and liner system wherein a liner is substantively secured within a bowl preventing unintended pet-removal while enabling simple removal by a human during a clean-up process.

The present invention relates to a pet bowl that is releasably securable to a stabilizing base that also stores a lid during pet use. Optional bowl liners are replaceable and disposable, allowing the use of the pet bowl system during travel without cleaning. A lid-lip sealing construction allow users to seal a lid over a partially used liner in the bowl for temporary storage or transport. An opening in the stabilizing base allows for the storage. Bowl liners may be individually sealed, include multiple sections, and may be sold separately for the travel convenience of pet owners. The bowl liners may also include a liner-lip sealing or other construction that secures the liner in the bowl during use while providing a rim-tab to enable easy removal.

According to an aspect of the present invention there is optionally provided a pet feeding system, comprising: a bowl having a lid removably sealing a open-top side of said bowl; lid sealing means for removably sealing said lid to said bowl open-top side, thereby enabling a temporary sealing of said bowl between uses; a stability base on a bottom-base side of said bowl member; and means for releasably securing said bottom-base side of said bowl to a top-side of said stability base during a use, thereby minimizing a tipping of said bowl relative to an external support surface for said stability base during said use.

According to another aspect of the present invention there is optionally provided a pet feeding system further comprising: at least one removable liner; said liner having a uniformly thin construction and being contoured to secure a close-fitting contact with at least a portion of said bowl proximate said open-top side; said liner including liner means for securing an upper edge portion of said liner to a rim portion of said bowl, thereby minimizing unintended displacement during said use; and said lid sealing means for removably sealing including liner-sealing means for sealing said lid over said liner to said bowl, thereby allowing said liner and said bowl to be sealed between said uses.

According to another aspect of the present invention there is optionally provided a pet feeding system further comprising: lid storage means for removably securing said lid to said stability member, thereby preventing an unintended loss of said lid.

According to another aspect of the present invention there is optionally provided a pet feeding system, wherein: said liner means for securing includes a liner rim construction covering a top portion of said rim portion of said bowl; said liner has a height between said rim liner construction and a bottom portion of said liner; said bowl includes a depth extending between said rim portion of said bowl and a bottom portion of said bowl; and said liner height is at least one of an equivalent to said depth of said bowl and an amount less than said depth of said bowl, whereby said liner may only partially fill said bowl, thereby allowing said feeding system to be adaptable to large and small pets.

According to another aspect of the present invention there is optionally provided a pet feeding system comprising: a bowl having a lid removably sealing a open-top side of said bowl; lid sealing means for removably sealing said lid to said bowl open-top side, thereby enabling a temporary sealing of said bowl between uses; a stability base on a bottom-base side of said bowl member; means for releasably securing said bottom-base side of said bowl to a top-side of said stability base during a use, thereby minimizing a tipping of said bowl relative to an external support surface for said stability base; and at least one removable liner having a uniformly thin construction and being contoured to secure a close-fitting contact with at least a portion of said bowl proximate said open-top side.

According to another aspect of the present invention there is optionally provided a pet feeding system further comprising: means for securing an upper edge portion of said liner to a rim portion of said bowl, thereby minimizing unintended displacement during said use; and said lid sealing means for removably sealing further comprising: liner-sealing means for sealing said lid over said liner to said bowl, thereby allowing said liner and said bowl to be sealed between said uses.

According to another aspect of the present invention there is optionally provided a pet feeding system comprising: a bowl having an open-top side; lid sealing means for removably sealing said lid to said bowl open-top side; a stability base; means for releasably securing a bottom-base side of said bowl to a top-side of said stability base during a use, thereby minimizing a tipping of said bowl relative to an external support surface for said stability base during a use; at least one removable liner being contoured to enable a close-fitting contact with at least a portion of said bowl proximate said open-top side; and said removable liner having at least one of a single compartment construction, a multiple compartment construction, a removable sealing-cover, and a liner rim removal tab.

The above, and other aspects, features and advantages of the present invention will become apparent from the following description read in conduction with the accompanying drawings, in which like reference numerals designate the same elements.

### BRIEF DESCRIPTION OF THE DRAWINGS

FIG. 1 is a perspective view of an assembled and packaged bowl system including a pack of disposable liners.

FIG. 2 is an exploded view of FIG. 1 without wrapping film.

FIG. 3 is a perspective assembled view of the embodiment in FIG. 1 positioned for use with a dual-chambered liner.

FIG. 4 is a cross-section of FIG. 3 along line I-I.

FIG. 5 is a partial sectional view of region II in FIG. 4.

FIG. 6 is a partial sectional view of region III in FIG. 4.

FIG. 7 is a partial sectional view of region IV in FIG. 4.

FIG. 8 is a partial section view of region V in FIG. 4.

FIG. 9 in a partially exploded view of FIG. 4 with liner removed.

FIG. 10 is a partial sectional view of region VI in FIG. 9 of the base top ring.

FIG. 11 is a partial sectional view of region VII in FIG. 9 of the bowl bottom.

FIG. 12 is a bottom exploded view of the base and lid.

FIG. 13 is partial sectional view of region VIII in FIG. 12.

FIG. 14 is a perspective lid-closed view of the embodiment in FIG. 3.

FIG. 15 is a cross-section view along line X-X in FIG. 14.

FIG. 16 is an alternative aspect of a bowl rim, lid, and liner assembly.

FIG. 17 is an alternative aspect of a bowl rim, lid, and liner assembly.

FIG. 18 is a perspective view of a sealed liner packet display at a point of purchase.

FIG. 19 is an exploded view of sealed liner packet prior to assembly with a wrapper.

FIG. 20 is an exploded view of a variant aspect of the present embodiment.

FIG. 21 is an alternative aspect of a bowl rim, lid, and liner assembly developed from a cross-sectional view along line IX-IX in FIG. 20.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

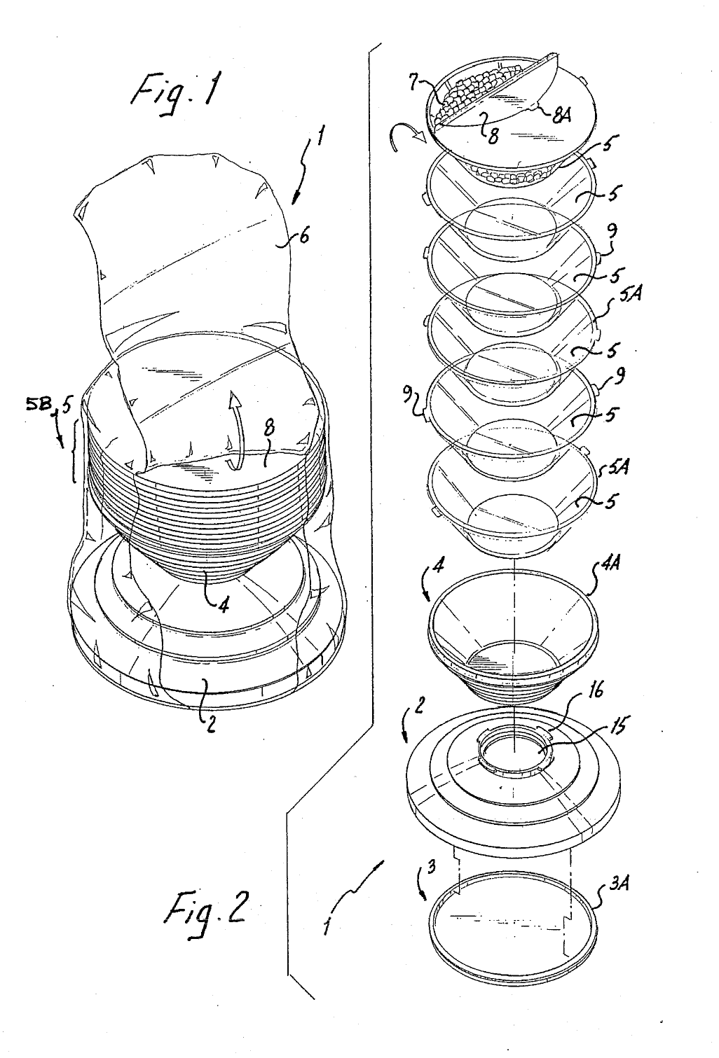

Referring now to FIGS. 1 and 2, a pet feeding apparatus 1 includes a support base member 2 supporting a bowl 4 and storing a lid 3 for bowl 4, packaged with a plurality of liners 5B (individually liners 5). A protective wrapping 6 encompasses apparatus 1 when assembled for sale.

FIG. 2 indicates an exploded view of the assembly in FIG. 1 and more clearly indicates particular details of the present system as will be discussed. As shown bowl 4 includes a bowl rim region 4A and lid 3 includes a lid rim region 3A.

As will be recognized by those of skill in the art, while the present preferred embodiment provides a circular shape for ease of plastic forming but it is readily envisioned that alternative shapes may be constructed without departing from the scope and spirit of the present invention, including square shapes, rectilinear, and polygonal sided shapes. As a consequence, while the present preferred embodiment is shown in a circular or round configuration, each aspect may be readily adapted to an alternative shape (square, rectangular, polygon) without departing from the teachings herein.

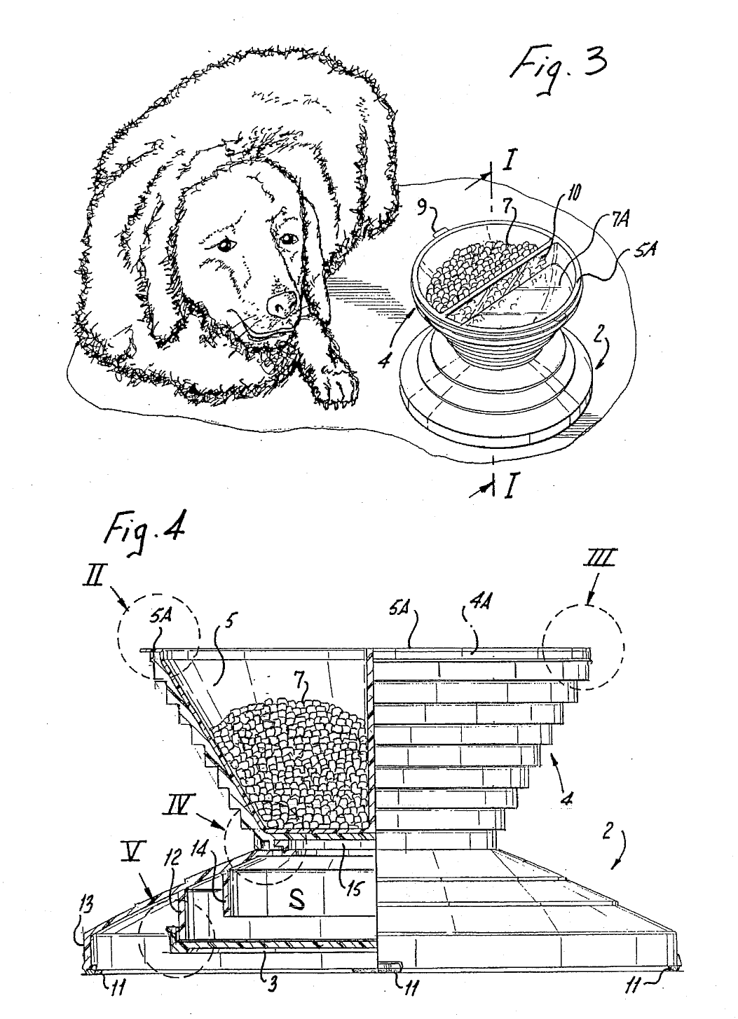

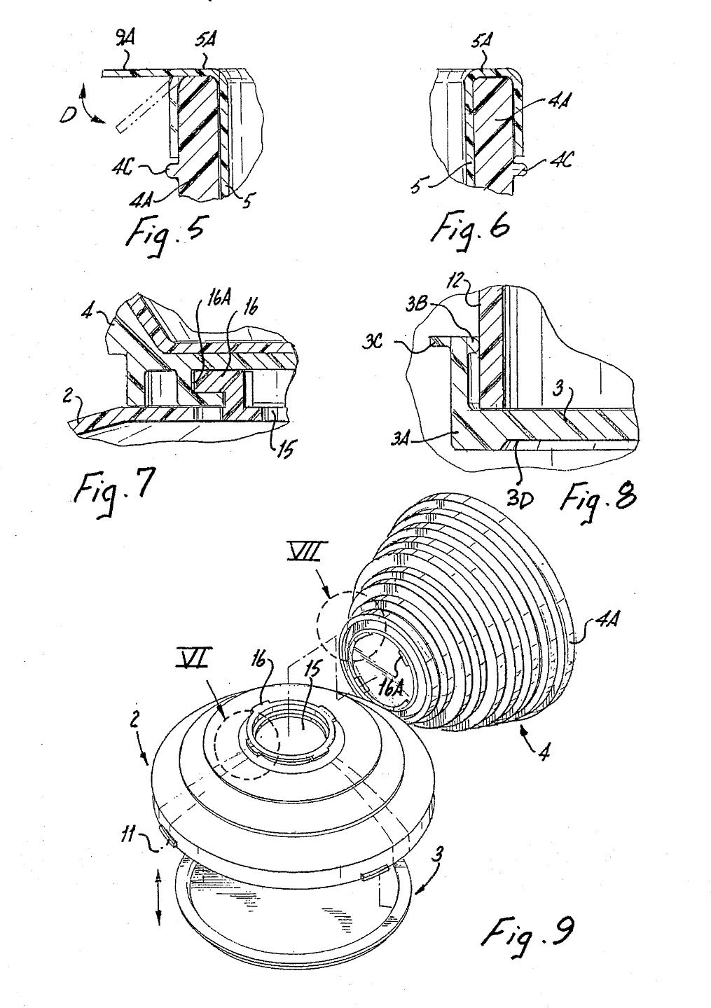

Liners 5 are shown including a liner rim region 5A and an optional projecting liner tab member 9 as will be discussed to aid removal and handling. As an optional assembly one or more liners 5 may be prepackaged with pet consumable items 7 such as food, water or snacks 7A or in combinations thereof in a multi-pack construction (FIG. 3). Where liners 5 are provided in a prepackaged condition a peal back film cover 8 having a pull tab member 8A is provided for ease of operation. While not shown in the schematic those of skill in the art will recognize that film cover 8 may be provided in an optional re-sealable configuration (not shown) as is know in the consumer products food arts (for example employ an adhesive or Velcro closure system).

As can be appreciated from the preferred embodiment in FIG. 2, liners 5 are stackable in a multi-pack and are easily readily stored inside bowl 4 for ready use at a preferred time.

Base 2 includes a central opening 15 and a plurality of engagement members 16 for engaging corresponding engagement slots 16A (FIG. 11) on a bottom of bowl 4 to provide a stable platform for pet-consumption while preventing unintended removal by a pet during use.

Referring now to FIGS. 3 and 4, liner 5A includes dual chambers divided by one or more dividing walls 10 (as shown) for storing alternative food items 7, 7A, shown here as food and water. As can be seen from the view in FIG. 3, base 2 is secured to a bottom of bowl 4 and lid 3 is optionally secured below base 2 (FIG. 2) to prevent unintended loss. As a consequence, assembly 1 may be provided to a pet in a compact form for ready use.

As is seen clearly in FIG. 4, food items 7 are positioned within liner 5 while liner rim 5A wraps over and secures to rim region 4A of bowl 4 (as shown). In an alternative construction noted in FIG. 5 (Section II), a liner rim lift-up member 9A may be optionally provided along liner rim 5A allowing a user to lift in a direction D (FIG. 5) providing an alternative to liner tab 9 as an aid in liner removal without risking any interference with lid rim 3A during attachment (as will be discussed).

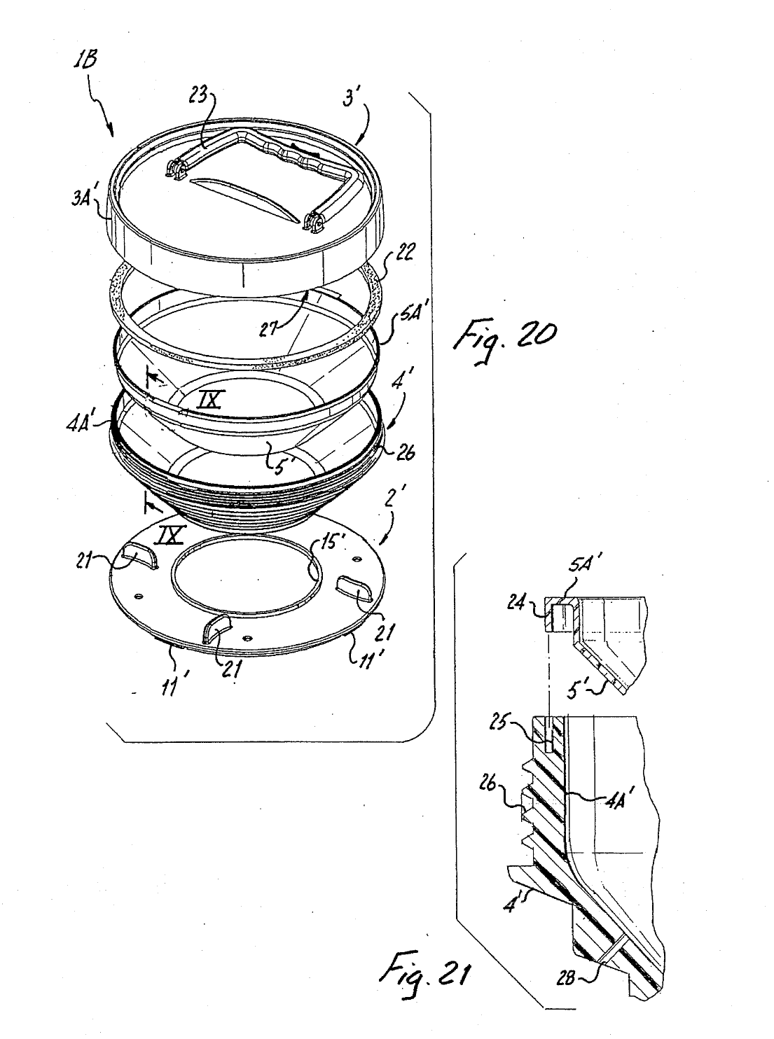

As shown, base member 2 includes a plurality of feet 11, supported along an outer rim wall 13, although those of skill in the art will readily recognize that alternative foot constructions may be provided without departing from the scope of the present invention. An inner rim member 14 bounds central opening 15 and an intermediate skirt rim 12 projects downwardly to engagably receive lid 3 (as shown). As will be appreciated by observing FIG. 4 an inner storage region S is bounded by lid 3 and opening 15 during the assembly shown. It is contemplated that spare liners 5 may be folded and stored in storage region S, as well as food items 7 (not shown), or alternative sealed packages 17 (FIG. 19) as will be discussed.

Referring now to FIGS. 5 and 6, it will b appreciated that bowl rim region 4A includes a lid engagement member 4C, shown here as a protuberance, boss, or ring on rim region 4A. As will also be appreciated herein, liner rim 5A includes a means (the U-shape here) for engaging bowl rim region 4A when liner 5 is pressed within bowl 4. In a preferred embodiment, a portion of liner rim region 5A is stippled or partially separated into one or more regions have a reduced shear strength allowing a user to grip a portion of the outer lip portion with a finger and pull upwardly in direction D to create a liner lift tab 9A. As a consequence, the present preferred embodiment envisions the circumstance wherein liner 5 readily seals to bowl rim 4A without interfering with lid engaging protuberance 4C. As will also be appreciated, lid engagement member 4C has a rather low profile to minimize difficulty with molding and manufacturing.

Referring now to FIG. 8, the outer perimeter of skirt rim 12 within base 2 includes is shaped with a dimension matching a dimension of an inner diameter of lid engagement member 3B so that during installation, a user may simply urge lid 3 onto the outer wall of skirt rim 12 to secure lid 3 in place. As will also be appreciated, lid 3 includes a lid grip profile 3C projecting outwardly from lid rim 3A allowing a user to readily grip an edge of rim 3 with a finger or small hand tool. As will be further appreciated from the instant construction, lid 3 proximate rim edge region 3A includes a narrow lid region 3D allowing a user to more easily flex lid grip tab 3C for use and assembly.

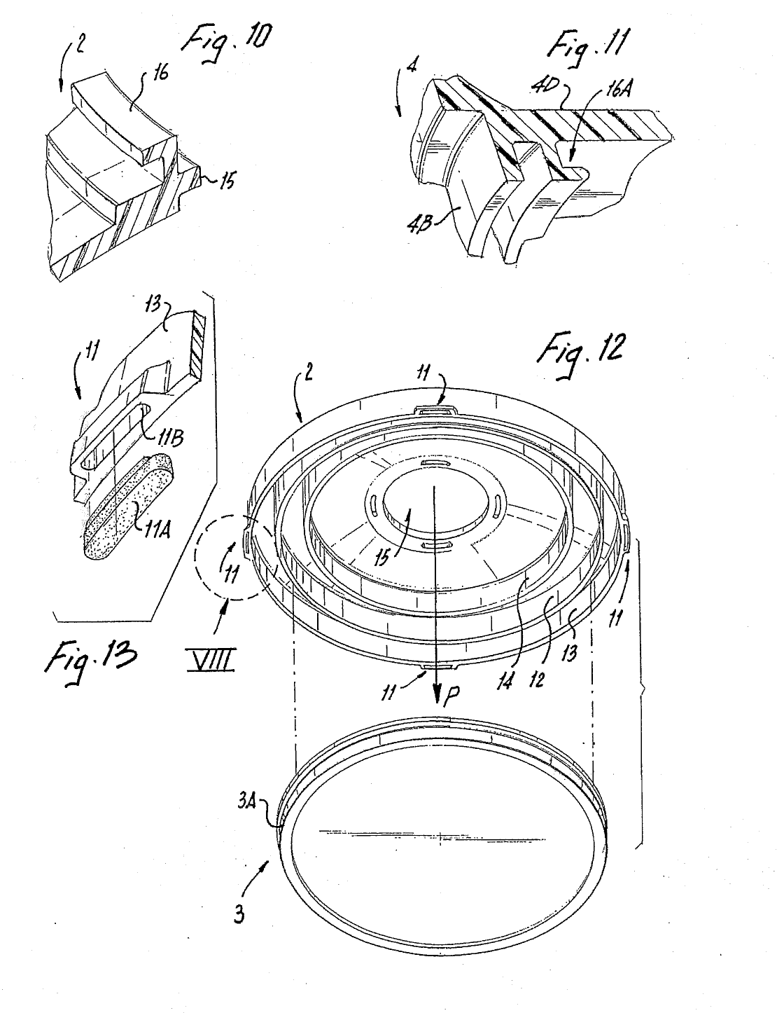

Referring now to FIGS. 7, 9, 10, and 11 it will be appreciated by those of skill in the art that a plurality of engagement members 16 are spaced about central opening 15 in base 2 and project outwardly to positively engage respective interrupted engagement slots 16A, formed on a base of bowl 4 proximate bowl base 4D and within an inner bowl base ring 4B. As can be seen, engagement slots 16A are shaped to receive male engagement members positioned at compass points about an outer periphery of central opening 15.

As a consequence, those of skill in the art will readily recognize that bowl 4 may be placed over base 2 and pivoted about a central position to pivotally engage male engagement members 16 with female engagement slots 16A. Thus, while the present preferred embodiment displays one interpretation of the present invention, those of skill in the art will readily recognize that members 16/16A function as engagement or securement means and may be readily replaced by other systems known in the art without departing from the scope and spirit of the present invention. For example, it is envisioned that alternatively a snap catch, magnetic engagement, electric engagement, or any other form of joining system used in the consumer items art group may be employed.

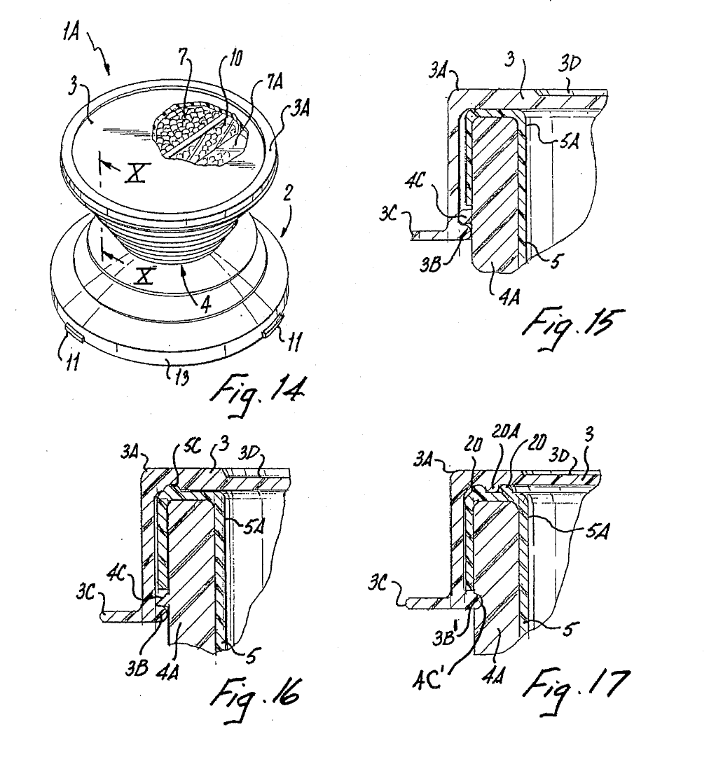

Referring now to FIGS. 12 and 13, feet 11 include elastomeric component 11A fixed within a receiving region 111B in outer rim wall 13 (as shown). Thus, while those of skill in the art of consumer product design may consider alternative construction for feet 111 (including a continuous foot about outer rim 13) to stabilize assembly 1, these alternative constructions are intended to be incorporated here within without departing from the scope of the present disclosure.

FIG. 12 also depicts a pushing direction P for easing removal of lid 3 from skirt rim 12 in base 2. As a result, while those users with small hands may readily engage lid lip member 3A, those with larger hands may simply remove bowl 4 and push lid 3 off skirt rim 12 along direction P by pushing through opening 15.

Referring now to FIG. 14 an alternative assembly 1A is provided in an assembled manner for purchase with lid 3 secured to bowl rim region 4A which seals liner 5 in place (as shown). In assembly 1A, it will be recognized that a liner 5 may also include covering film 8 (FIG. 2) without departing from the invention. Here, assembly 1A may be individually wrapped for use by a user and covered with lid 3 for transport prior to use, providing a clean transport vehicle.

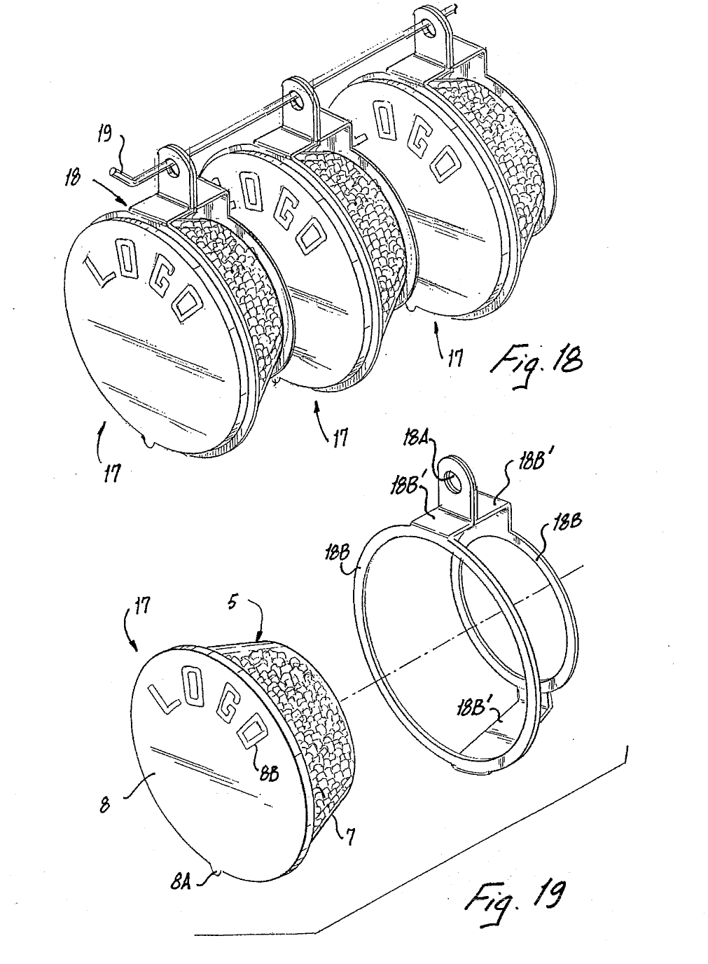

Referring now to FIG. 15, it will be appreciated that lid 3 with reduced central profile 3D may be press-fitted over liner rim 5A and bowl rim 4A to securely engage bowl engagement rim 4C and thereby seal liner 5 and lid 3 to bowl 4. An alternative construction to FIG. 15 is shown in FIGS. 16 and 17.

In FIG. 16, an alterative aspect of the present invention provides a liner protuberance 5C projecting upwardly from liner 5 formed during manufacturing. Protuberance 5C provides for the easy addition of sealing film 8 about an outer periphery of liner 5 and a corresponding recess (shown but not numbered) in lid 3 acts to pinion liner 5 in place with an air-tight seal for food preservation and to prevent fluid leaks (water leaks).

Referring now to FIG. 17, yet another constructive aspect of the invention is provided with an internally projecting lid engagement member 3B′ receivable within a corresponding receiving and sealing recess 4C′, as shown in bowl rim region 4A. One benefit from this construction is that the outer periphery wall of lid rim 3A provides a snug fit to the outer periphery wall of liner rim 5A. The construction involving 3B′/4C′ is also shown assembled with an alternative employment of two annular rings 20, 20, formed in liner rim 5A to engage a corresponding protuberance 20A in lid 3.

As a consequence of the above discussion, those of skill in the art will readily recognize that a number of assemblies are disclosed that collectively may be references as lid sealing means for connecting a lid to either bowl rim region 4A or to secure rim 3 to base 2 along skirt rim 12. Similarly, it should be recognized by those of skill in the art that liners 5 may be formed with adaptive rim shapes that aid in removably securing liners 5 (including packs of liners 5B in FIG. 1) to bowl rim region 4A while simultaneously allowing lid 3 to seal optionally bowl 4 (without liner) or bowl 4 with liner 5.

Referring now to FIGS. 18-19, a liner package 17 is shown at a point of purchase rack display bar 19 supported by a support wrapper 18. As shown, liner package 17 includes a liner 5 containing a pet consumable item 7 and sealed with sealing film 8 having an optional display logo 8B. A film lift tab 8A is shown for user convenience.

Wrapper 18 is constructed from a set of retaining rings 18B, 18B, joined by respective support web members 18B′. At a top position, support web member 18B′ is split to form a retaining ring 18A for receiving display bar 19 prior to sale.

As a consequence of this alternative aspect of the present invention, it is envisioned that assembly 1, 1A, and others may be readily purchased either with or without liners 5, but that consumers may later purchase individually wrapped and sealed bowl liners 17 provided by various pet-food manufacturers shown at logo 8B. As a consequence this invention also encompasses a kit use wherein an individual bowl assembly 1 may be later augmented as a kit with one or more pre-packaged and pre-sealed liners 17. It is also envisioned that a user may buy separately sold assemblies 5B of liners 5 (FIG. 1).

Referring now to FIGS. 20 and 21, an alternative assembly 1B includes a bowl member 4′ and a travel lid member 3′ having a travel lid rim 3A′. Bowl 4′ includes a bowl rim 4A′ that on an outer surface thereof includes a plurality of projecting threads 26 for threadably engaging corresponding female threaded regions 27 on an inner periphery surface of travel lid rim 3A′ (labeled but not shown).

Also shown are a support base member 2′ including a plurality of feet members 11′, and a corresponding number of upwardly projecting bowl support and stabilization members 21 surrounding a central opening region 15′.

A liner 5′ includes a liner rim 5A′ for engaging bowl rim region 4A′ as shown. Here, liner rim portion 5A′ includes a downwardly projecting seal member 24 formed to engage a female receiving slot 25 formed intermediate on bowl rim 4A′.

A handle 23 is provided on a top surface of lid 3′ and an elastomeric sealing member 22 may be optionally positioned on top of liner rim 5A′ to be urged into a sealing contact during a threaded engagement between lid 3′ and threaded members 26 of bowl 4′.

As will be appreciated in each of the earlier bowl/liner rim interconnections, as liners 5/5′ approach rims 4A, 4A′ a volume of atmospheric air must escape there between to allow proper seating. As liners 5‘5’ are pressed downwardly therefore a “pressure-flow” fit is achieved by allowing atmospheric air to escape so that liners 5/5′ fit tightly proximate bowl rim regions 4A, 4A′ much in the same sense as a common Tupperware™ product seals with it's lid—the atmospheric pressure retains the liner in place along with common surface friction, static forces, and electro-magnetic Van der Waals forces. While such a pressure-flow fit is sufficient for most purposes it may be useful to ease removal to include liner tabs 9, 9A to ease removal.

The present construction shown in FIG. 21 seals liner 5′ tightly within bowl 4′ requiring (in a preferred construction) one or more tiny pressure release openings 28 provided will above any common liquid use level in either bowl 4′ or liner 5′. During sealing, as rim hoop 24 engages receiving slot 25 the rim is sealed and an air-escape is required for further pressing of liner 5′ into position in bowl 4′. Thus, during removal, a tab on liners 5′ (shown in FIG. 20 but not described), may be lifted aided by air entering via holes 28 to allow the removal of liners 5′ for disposal.

Finally, as should be additionally understood by those having reviewed the disclosure above, base 2, 2′ having a generally conical or concave shape for stability may be alternatively formed without departing from the scope and spirit of the present invention. Particularly, it is noted that in an alternative embodiment (not shown) base 2 may be shaped as an alternate second bowl member, whereby assembly 1 may be alternatively provided with two bowls, separable for individual use, or joinable for use wherein one bowl serves as the support stability base and the second bowl serves as bowl 4 as discussed above.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A pet feeding system, comprising:
a bowl having a lid removably sealing a open-top side of said bowl;
lid sealing means for removably sealing said lid to said bowl open-top side, thereby enabling a temporary sealing of said bowl between uses;
a stability base on a bottom-base side of said bowl member; and
means for releasably securing said bottom-base side of said bowl to a top-side of said stability base during a use, thereby minimizing a tipping of said bowl relative to an external support surface for said stability base during said use.

2. A pet feeding system, according to claim 1, further comprising:
at least one removable liner;
said liner having a uniformly thin construction and being contoured to secure a close-fitting contact with at least a portion of said bowl proximate said open-top side;
said liner including liner means for securing an upper edge portion of said liner to a rim portion of said bowl, thereby minimizing unintended displacement during said use; and
said lid sealing means for removably sealing including liner-sealing means for sealing said lid over said liner to said bowl, thereby allowing said liner and said bowl to be sealed between said uses.

3. A pet feeding system, according to claim 1, further comprising:
lid storage means for removably securing said lid to said stability member, thereby preventing an unintended loss of said lid.

4. A pet feeding system, according to claim 2, further comprising:
lid storage means for removably securing said lid to said stability member, thereby preventing an unintended loss of said lid.

5. A pet feeding system, according to claim 2, wherein:
said liner means for securing includes a liner rim construction covering a top portion of said rim portion of said bowl;
said liner has a height between said rim liner construction and a bottom portion of said liner;
said bowl includes a depth extending between said rim portion of said bowl and a bottom portion of said bowl; and
said liner height is at least one of an equivalent to said depth of said bowl and an amount less than said depth of said bowl, whereby said liner may only partially fill said bowl, thereby allowing said feeding system to be adaptable to large and small pets.

6. A pet feeding system, according to claim 2, wherein:
said liner means for securing further includes a liner removal tab member for aiding removal of said liner from said bowl following said use.

7. A pet feeing system, according to claim 5, further comprising:
means for forming and releasing a pressure-flow fit removably securing said liner in said bowl during said use;
said means for forming and releasing including at least one pressure passage between an interior of said bowl proximate said rim portion of said bowl and an exterior of said bowl; and
said means for forming and releasing further including at least one liner removal tab member in said liner rim construction, whereby during an insertion of said liner in said bowl said liner and said liner rim construction urges atmospheric gas trapped between said liner and said bowl outward along said at least one pressure passage to provide a pressure-flow fit to resist removal of said liner from said bowl and upon a user lifting said liner by said liner removal tab member a removal-volume of atmospheric gas releases said pressure-flow fit of said liner.

8. A pet feeding system, according to claim 3, further comprising:
a skirt rim member in said lid storage means for removably securing said lid; and
said skirt member projecting away from means for releasably securing said bowl to said stability member, whereby a bounded storage region is formed between said lid in a stored condition and said means for releasably securing.

9. A pet feeding system, according to claim 8, further comprising:
an outer rim on said stability base;
an inner rim on said stability base;
said skirt rim being between said outer rim and said inner rim.

10. A pet feeding system, according to claim 8 further comprising:
a bounded opening in said top-side of said stability base; and
said bounded opening enabling an access to said bounded storage region when said lid is removably secured to said skirt rim member.

11. A pet feeding system, according to claim 1, wherein:
said means for releasably securing said bottom-base side of said bowl to a top-side of said stability base during said use includes at least one of a physical connection, a magnetic connection, a vacuum release connection, and an electronic connection, whereby said bowl may be removed from said stability base for filling with an external liner or food member and re-secured to said stability base.

12. A pet feeding system, according to claim 11, wherein:
said physical connection includes at least one of a Velcro connection, a mechanical male-female connection, and a snap-catch connection.

13. A pet feeding system, according to claim 12, wherein:
said physical connection is said mechanical male-female connection;
said male-female connection further comprising:
at least a first male engagement member and a second female engagement member;
said at least first male engagements member being on one of said bowl and said stability base and said at least second female engagement member being on said other one thereof; and
said at least second female engagement member physically engaging said first male member, whereby said means for releasably securing provides a secure connection there between.

14. A pet feeding system, according to claim 2, wherein:
said removable liner includes at least a first and a second storage compartment for storing consumable items, whereby during said use two alternative options are presented for pet feeding.

15. A pet feeding system according to claim 2, further comprising:
at least a first removable film cover sealably covering a top portion of said at least one liner, whereby prior to said use said liner is sealed to prevent loss of stored consumables.

16. A pet feeding system, comprising:
a bowl having a lid removably sealing a open-top side of said bowl;
lid sealing means for removably sealing said lid to said bowl open-top side, thereby enabling a temporary sealing of said bowl between uses;
a stability base on a bottom-base side of said bowl member;
means for releasably securing said bottom-base side of said bowl to a top-side of said stability base during a use, thereby minimizing a tipping of said bowl relative to an external support surface for said stability base; and
at least one removable liner having a uniformly thin construction and being contoured to secure a close-fitting contact with at least a portion of said bowl proximate said open-top side.

17. A pet feeding system, according to claim 16, further comprising:
means for securing an upper edge portion of said liner to a rim portion of said bowl, thereby minimizing unintended displacement during said use; and
said lid sealing means for removably sealing further comprising:
liner-sealing means for sealing said lid over said liner to said bowl, thereby allowing said liner and said bowl to be sealed between said uses.

18. A pet feeding system, according to claim 16, wherein:
said lid sealing means includes at least one of a elastic snap fit and a threaded fit, whereby said lid sealing means prevents unintended removal of said lid from said bowl open-top side during said use.

19. A pet feeding system, according to claim 16, further comprising:
lid storage means for removably securing said lid to said stability member, thereby preventing an unintended loss of said lid during said use.

20. A pet feeding system, comprising:
a bowl having an open-top side;
lid sealing means for removably sealing said lid to said bowl open-top side;
a stability base;
means for releasably securing a bottom-base side of said bowl to a top-side of said stability base during a use, thereby minimizing a tipping of said bowl relative to an external support surface for said stability base during a use;
at least one removable liner being contoured to enable a close-fitting contact with at least a portion of said bowl proximate said open-top side; and
said removable liner having at least one of a single compartment construction, a multiple compartment construction, a removable sealing-cover, and a liner rim removal tab.

21. A pet feeding kit, comprising:
a bowl having an open-top side;
lid sealing means for removably sealing said lid to said bowl open-top side;
a stability base removably secured to a bottom-base side of said bowl during a use, thereby minimizing a tipping of said bowl relative to an external support surface for said stability base during a use;
at least one removable liner being contoured to enable a close-fitting contact with at least a portion of said bowl proximate said open-top side, and
said liner being accessibly-sealed and containing at least one pet-consumable item.
